(19) United States
(12) Patent Application Publication
(10) Pub. No.: US 2026/0252864 A1
(43) Pub. Date: Aug. 27, 2026

(54) METHODS AND SYSTEMS FOR POST-TRAINING QUANTIZATION OF NEURAL NETWORKS

(71) Applicant: Royal Bank of Canada, Toronto (CA)

(72) Inventors: Yuqiao WEN, Edmonton (CA); Yanshuai CAO, Toronto (CA); Lili MOU, Edmonton (CA)

(21) Appl. No.: 19/059,635

(22) Filed: Feb. 21, 2025

(51) Int. Cl. G06N 3/0495; G06N 3/086

(52) U.S. Cl. CPC G06N 3/0495; G06N 3/086

(57) ABSTRACT

Disclosed are methods and systems for post-training quantization of a neural network. The systems comprise computer processing and memory means for carrying out the methods. The methods comprise sequentially selecting one of a plurality of layers in the neural network. The methods also comprise, for each selected layer, sampling a transformation associated with the selected layer, quantizing the neural network using the sampled transformation and calculating a loss associated with the quantization. The methods also comprise determining the acceptability of the calculated loss using a discrete search algorithm and accepting the sampled transformation if the loss is determined to be acceptable.

### TECHNICAL FIELD

The present disclosure generally relates to the field of artificial intelligence. In particular, various embodiments are described herein that relate to methods and systems for post-training quantization of neural networks.

### BACKGROUND

The following paragraphs are provided by way of background to the present disclosure. They are not, however, an admission that anything discussed therein is prior art or part of the knowledge of persons skilled in the art.

Large language models (LLMs) have been increasing in size due to their capabilities at accomplishing a wide range of natural language processing (NLP) tasks, particularly because of how well performance scales with more and more parameters. This has resulted in a pressing need to reduce the memory usage of LLMs and improve their inference efficiency to make them more accessible.

One technique that has been developed to achieve this is called post-training quantization (PTQ), which is used to reduce the memory and computational requirements of a trained model, typically by converting the model's weights and/or activations from higher precision, e.g., 32-bit floating point, to lower precision, e.g., 8-bit integer (see [18]). This process is applied after the model has already been trained and aims to make the model more efficient, particularly for deployment on resource-constrained devices like smartphones or embedded systems. Existing methods of PTQ improves quantization performance through model invariance, scaling or rotating model parameters such that the resulting model performs better after quantization.

While quantization reduces the model size, it also causes rounding errors and typically leads to performance degradation. This is especially challenging in an ultra-low-bit setting, for example, using only two or three bits to represent a model weight. Prior art methods of quantization have sought to find an invariant model of the pretrained LLM that reduces rounding errors after quantization and preserves performance. Known methods are directed to finding an invariant model by either manually designed heuristics or gradient-based methods. For example, the method disclosed in [25] reduces rounding errors by weight scaling and handcraft how much to scale based on activation values. The method disclosed in [34] proposes block-wise error minimization to find a scale-invariant model through gradient updates. The method disclosed in [28] uses gradient-based methods and finds rotation matrices by directly optimizing cross-entropy loss.

One significant difficulty with gradient-based methods is that quantization functions have zero gradient almost everywhere, and so such methods must approximate the gradient with straight-through estimation, as described in more detail in [3]. In addition, the optimization process is often constrained, and ad hoc treatments are required to ensure that the gradient-updated transformation satisfies the desired form. For example, in the method described in [28], the Cayley SGD method must be applied to keep the weight matrix orthogonal.

Accordingly, there is a need for improved methods and systems for post-training quantization of neural networks that address the challenges and/or shortcomings described above.

### SUMMARY

Various embodiments of methods and systems for post-training quantization of neural networks are provided according to the teachings herein, which allow for the use of multiple types of invariant transformation, and which include an activation-guided discrete search method particularly well-suited to permutation invariance.

According to an aspect of the present disclosure, there is provided a method of post-training quantization of a neural network. The method comprises sequentially selecting one of a plurality of layers in the neural network. The method also comprises, for each selected layer, sampling a transformation associated with the selected layer, and quantizing the neural network using the sampled transformation. The method also comprises calculating a loss associated with the quantization and determining the acceptability of the calculated loss using a discrete search algorithm. The method also comprises accepting the sampled transformation if the loss is determined to be acceptable.

In accordance with another aspect of the present disclosure, there is provided a system for post-training quantization of a neural network. The system comprises at least one database having stored thereon a neural network and at least one processor communicatively coupled with the at least one database. The system also comprises at least one memory communicatively coupled to the at least one processor, the at least one memory having stored thereon computer program code that is executable by the at least one processor and that, when executed by the at least one processor, causes the at least one processor to perform a method. The method comprises sequentially selecting one of a plurality of layers in the neural network. The method also comprises, for each selected layer, sampling a transformation associated with the selected layer, and quantizing the neural network using the sampled transformation. The method also comprises calculating a loss associated with the quantization and determining the acceptability of the calculated loss using a discrete search algorithm. The method also comprises accepting the sampled transformation if the loss is determined to be acceptable.

In accordance with yet another aspect of the present disclosure, there is provided at least one non-transitory computer readable medium having stored thereon computer program code that is executable by at least one processor and that, when executed by the at least one processor, causes the at least one processor to perform a method. The method comprises sequentially selecting one of a plurality of layers in the neural network. The method also comprises, for each selected layer, sampling a transformation associated with the selected layer, and quantizing the neural network using the sampled transformation. The method also comprises calculating a loss associated with the quantization and determining the acceptability of the calculated loss using a discrete search algorithm. The method also comprises accepting the sampled transformation if the loss is determined to be acceptable.

In some examples, the discrete search algorithm is one of a simulated annealing algorithm, a genetic algorithm or a hill climbing algorithm.

In some examples, the discrete search algorithm is a hill climbing algorithm and determining the acceptability of the calculated loss further comprises accepting the sampled transformation only if the calculated loss is smaller than a smallest previous loss associated with the same layer.

In some examples, the transformation comprises two or more of: a permutation of a plurality of weights in the selected layer; a scaling of a plurality of weights in the selected layer; and a rotation of a plurality of weights in the selected layer.

In some examples, quantizing further comprising using standard asymmetric integer group quantization in which weight matrices are divided into groups of contiguous memory space.

In some examples, the permutation comprises reshuffling the weights of neurons in the selected layer and the scaling and the rotation each comprise using a random walk technique and sampling the scale and rotation degrees based on a Gaussian distribution centered as current values.

In some examples, the step of sequentially selecting one of a plurality of layers in the neural network comprises selecting one or more layer multiple times.

In some examples, the calculated loss is based in part on the cross-entropy loss and an activation matching loss associated with the transformation.

In some examples, the calculated loss is determined using the equation:

$${ℒ}^{′} ← CE ( X , quant ( {θ}^{′} ) ) + α MSE ( H , {H}_{0} ) ) .$$

where X is a batch of calibration data, H and H₀ are the activations of the quantized model and the original model, respectively, θ′ are model parameters, CE is the standard cross-entry loss, MSE is a calculation of the mean squared error, and α is a hyperparameter.

Other features and advantages of the present disclosure will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein. In the drawings:

FIG. 1 shows a computer network suitable for implementing embodiments in accordance with systems and methods of the present disclosure;

FIG. 2 shows a computing device suitable for implementing embodiments in accordance with systems and methods of the present disclosure;

FIG. 3 is flowchart representing embodiments in accordance with methods of the present disclosure;

FIG. 4 is flowchart representing embodiments in accordance with methods of the present disclosure;

FIG. 5 is a first optimization curve for an example model across different numbers of calibration sequences, namely the calibration loss on the Pile corpus;

FIG. 6 is a second optimization curve for an example model across different numbers of calibration sequences, namely the perplexity scores on WikiText-2; and

FIG. 7 is a third optimization curve for an example model across different numbers of calibration sequences, namely the acceptance ratio of sampled transformations.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to systems or methods having all of the features of any one of the systems or methods described below or to features common to multiple or all of the systems or methods described herein. It is possible that there may be a system or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Some elements herein may be identified by a part number, which is composed of a base number followed by an alphabetical or numerical suffix (e.g., 184A, or 184₁). Multiple elements herein may be identified by part numbers that share a base number in common and that differ by their suffixes (e.g., 184₁, 184₂, and 184₃). All elements with a common base number may be referred to collectively or generically using the base number without a suffix (e.g., 184).

The example embodiments of the systems or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including one or more of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level programming language. The program code may be written in Rust, C++, C#, JavaScript, Python, or any other suitable programming language and may comprise modules or classes, as is known to those skilled in the art. Alternatively, or in addition thereto, some of these elements implemented via software may be written in assembly language, machine language, or firmware as needed. In either case, the language may be a compiled or interpreted language.

At least some of the computer programs associated with the systems and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

As used herein, the term “permutation invariance” means the property where the performance or behavior of a neural network layer remains consistent regardless of the order (permutation) in which the input elements are presented. This is important when the order of the input elements is irrelevant, and the model should focus only on the content or the relationships among the elements, not their arrangement.

As used herein, the term “scaling invariance” means the property where the performance or behavior of a neural network layer remains consistent despite changes in the scale or magnitude of the input data or the model parameters themselves.

As used herein, the term “rotation invariance” means the property where the performance or behavior of a neural network layer remains consistent when parameters (such as weights) are rotated in a certain way.

As used herein, the term “quantization” generally means the process of mapping continuous or high-precision values into a smaller set of discrete values. In the context of neural networks and machine learning, it typically refers to the reduction of the precision of a model's parameters (such as weights, biases, and activations) from floating-point numbers (which have high precision) to lower precision formats, such as integers. Quantization may be used to reduce the memory and computational requirements of a model, making it more efficient, especially for deployment on resource-constrained devices like mobile phones, embedded systems, or edge devices.

As use herein, “quantization” generally refers to integer quantization, where model weights are stored as integers, as disclosed in [20]. Integer quantization is a common quantization schemes because it offers strong performance, high memory savings, as well as hardware efficiency with integer-only arithmetic during inference in certain scenarios, as disclosed in [20]. Prior art methods have explored binary networks that can only represent ±1, or ternary networks which additionally include the 0 value, as disclosed in [7]. Such methods, however, only work with small models for simple tasks. Other methods, such as those disclosed in [23], typically use more bits (e.g., 4-8 bits) in integer quantization to address real-world tasks, but the ultra-low-bit setup remains challenging to implement.

Low-bit integers are usually unable to cover the range of real-valued weights. Therefore, in some prior art methods, a scale parameter is introduced to map the low-bit integer range to the original weight range, as described in [47]. Moreover, because it is important to keep the exact 0 value for weights, a zero-point parameter is also typically introduced, as disclosed in [20]. Such offset and scaling are applied at the granularity of groups (contiguous weights in a matrix). Although the scale and zero-point parameters use additional memory, they may significantly improve performance and are commonly used in modern integer quantization methods, as disclosed in [13], [25], and [34].

One method of integer quantization is to quantize weights sequentially, as disclosed in [12] and [13], which is inspired by classic pruning methods, such as that disclosed in [19]. The general concept is that, given already quantized weights, the rest weights are finetuned to compensate the quantization error before also being quantized. The weight updates are however computed in a closed form based on second-order gradient information; this is done for each layer separately, which does not consider the dependencies among layers.

An alternative method for integer quantization is to leverage model invariance, which adjusts the parameters for better quantization performance without impacting the (un-quantized) behavior of a model. Some such prior art methods use various heuristics. For example, the method disclosed in [25] determines the scaling coefficients based on the magnitude of the activations, while the method described in [24] manually designs a zigzag permutation pattern in an attempt to distribute outlier weights throughout the network. In other methods, gradient-based processes are used to learn scaling coefficients, as described in [34], and orthogonal transformations, as described in [28]. These methods however require a straight-through gradient estimation and special treatment for the constraint, as described in more detail elsewhere herein.

There are also other ways to represent model weights in a low-bit fashion, such as floating point quantization, as disclosed in [15], and vector quantization, as disclosed in [17]. Floating-point quantization mostly follows the widely adopted IEEE 754 standard (4610935), where values are represented with a sign bit for polarity, exponent bits for magnitude, and mantissa bits for precision. The exponent bits enable the floating-point representation to cover a wide range of values, which is especially advantageous during training, as disclosed in [40]. To save memory, some methods, such as those disclosed in [31], propose mixed-precision training, which has resulted in methods focusing on designing different bit representations suitable for training, such as those disclosed in [40], [36] and [37]. Other prior art processes have incorporated adaptive methods, which dynamically adjust the floating-point representation, as disclosed in [22] and [27].

Such floating point methods usually lack hardware support and are generally not suitable for the ultra-low-bit settings, as the allocation of bits to express the exponent can typically not be afforded. On the other hand, vector quantization methods compress model weights by storing a set of representative vectors, also known as a codebook, as described in [16]. Methods such as QuiP #, as disclosed in [39], and AQLM, as disclosed in [11], may therefore be considered.

Quantization can be applied to weights only or both weights and activations. Quantizing activation is more technically challenging than quantizing weights, because of the emergence of outlier features in large language models, as disclosed in [8] and [43]. Weight-activation quantization may use hardware integer arithmetic for fast inference, but it is significantly more challenging, with known methods still requiring 4 to 6 bits, as disclosed in [41], [44] and [34].

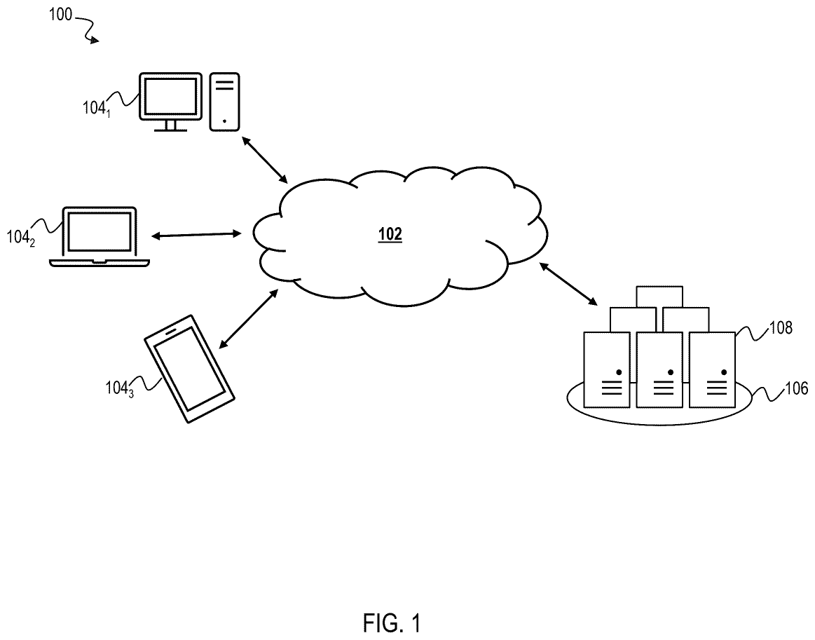

Referring now to FIG. 1, there is shown a computer network 100 that comprises an example embodiment of a system implementing the systems and methods described herein. More particularly, the computer network 100 comprises a wide area network 102 such as the Internet to which various user devices 104x and data center 106 are communicatively coupled. The data center 106 comprises a number of servers 108 networked together to collectively perform various computing functions, such as those described herein.

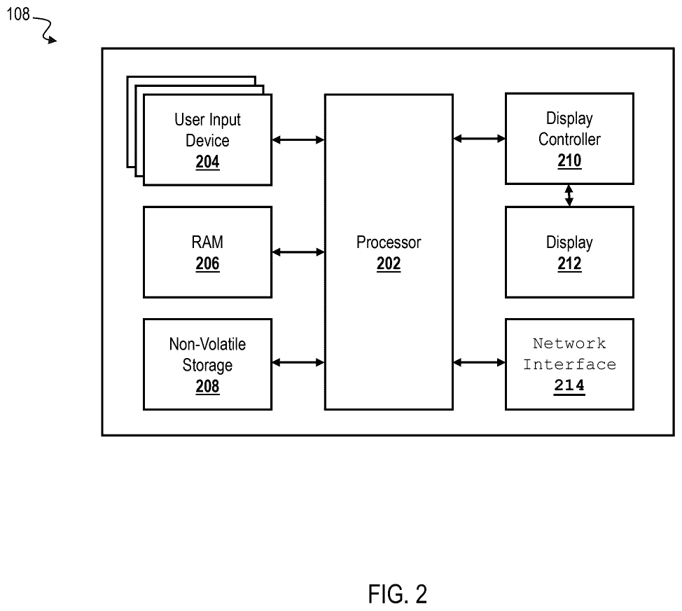

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106.

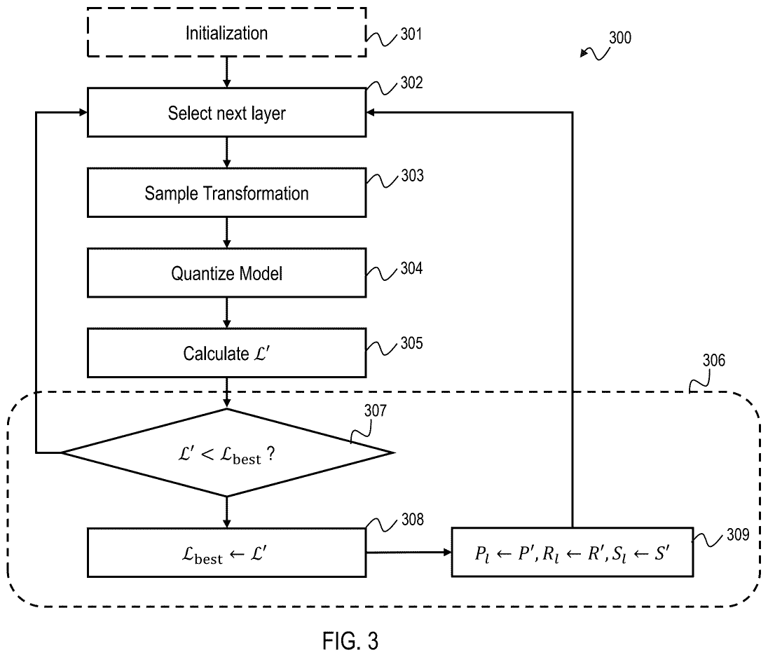

The non-volatile storage 208 has stored on it computer program code that is loaded into the RAM 206 at runtime and that is executable by the processor 202. When the computer program code is executed by the processor 202, the processor 202 causes the server 108 to implement methods such as those shown in of FIG. 3, which are described in more detail elsewhere herein. Additionally, or alternatively, the servers 108 may collectively perform that method using distributed computing. While the system depicted in FIG. 2 is described specifically in respect of one of the servers 108, analogous versions of the system may also be used for the user devices 104.

The inventors have appreciated that an invariant model can be obtained by applying a transformation and its inverse to neighboring linear blocks in a neural network. In accordance with the teachings herein, there are provided various embodiments for a unified method for systematically exploring model invariance. Some embodiments of the methods and systems described herein also allow the exploration of permutation and rotation invariance, which cannot be easily optimized, especially since permutation is non-differentiable and cannot be trained using gradient-based methods. Moreover, although permutation is a special case of orthogonal transformations, previous gradient-based optimization (see [28]) cannot easily explore permutation invariance, as permutation creates symmetric local optima in a non-convex fashion. To address these and other technical challenges, embodiments of the systems and methods disclosed herein provide a process and discrete search algorithms that may optimize scaling, rotation, and permutation at the same time.

In some embodiments, at each step of the process, a sample of a combination of different invariant transformations (e.g., permutation, rotation and/or scaling) for a given layer of the LLM are taken. The updated model is then evaluated based on how well it matches the activation of the original model as well as its perplexity on a fixed, small calibration set (e.g., containing only 512 tokens, which is shorter than the context window).

Once the loss is calculated for a particular transformation, a discrete search algorithm is used to assess whether the transformation should be kept, or whether it should be rejected. As used herein, the expression “discrete search algorithm” means any algorithm used to search for a solution in a discrete set of states. Discrete search algorithms are said to “explore” a space where each possible state can be individually identified.

In some embodiments, the discrete search algorithm used by the methods and systems disclosed herein may be simulated annealing, which is a probabilistic optimization algorithm used to minimize or find the best possible configuration of weights or activations within a neural network layer. As would be understood by someone skilled in the art of machine learning, when applied to the methods and systems of the present invention, the objective function of the simulated annealing could be based on the loss associated with the transformation, as described in more detail elsewhere herein. Thus, instead of using standard gradient-based optimization methods (like SGD or Adam), simulated annealing can adjust the weights of the network by exploring various configurations and settling into a configuration that minimizes the loss.

In other embodiments, the discrete search algorithm used by the methods and systems disclosed herein may be a genetic algorithm, which is another type of optimization algorithm. The genetic algorithm may use mechanisms such as selection, crossover (recombination), and mutation to evolve a population of possible solutions toward an optimal or near-optimal solution. As will be well understood by someone skilled in the art of machine learning, in performing transformations on a layer of a neural network, the genetic algorithm can be used to explore and optimize different configurations of weights for the layer.

In yet other embodiments, such as those described in greater detail elsewhere herein, a hill climbing optimization may be adopted and only changes that improve the model are accepted. The methods and systems disclosed herein therefore provide a lightweight quantization method, as they only require forward passes for a small number of tokens on a quantized model.

As will be understood by the skilled reader, while only the application of the hill climbing discrete search algorithm has been described in detail herein, the application of alternative discrete search algorithms, such as those mentioned herein, would be understood to persons of ordinary skill in the art of machine learning.

Accordingly, the methods and systems described herein provide a way to simultaneously explore different types of invariant transformations. The methods and systems described herein also provide an activation-guided discrete search algorithm which is specifically suitable for permutation invariance.

Results show that these methods and systems are compatible with known quantization methods, allowing the methods and systems disclosed herein to achieve an add-on performance improvement over other known methods and systems. As described in more detail elsewhere herein, experiments were conducted on language modeling tasks and natural language understanding tasks and results show that the methods disclosed herein are orthogonal to existing quantization methods.

While the methods and systems disclosed herein use a weight-only setup for ultra-low-bit quantization, they do not use more memory when storing the model because the activation values are temporary variables during inference.

The systems and methods disclosed herein may make use of standard asymmetric integer group quantization, as disclosed in [20], for example, where weight matrices are divided into groups of contiguous memory space. In particular, each group may be quantized separately based on a scale parameter that specifies the step size between integer values. Asymmetric quantization allows a zero-point parameter to specify the (integer) offset for the zero value.

Let W_{g}∈ [symbol] ^{G} be the gth group containing G contiguous parameters of the weight matrix. Asymmetric integer quantization may then take the following form:

$$quant ( {W}_{g} ) = round ( {W}_{g} / {s}_{g} ) + {z}_{g} \qquad ( 1 )$$

where quant is the quantization function, s_{g} is the FP16 scale parameter, and z_{g} is an integer parameter specifying the zero point.

An aim is to map the maximum and minimum (un-quantized) values with the largest and smallest integers. This leads to closed-form solutions for the scale and zero-point parameters:

$${s}_{g} = \frac{max ( {W}_{g} ) - min ( {W}_{g} )}{{q}_{max} - {q}_{min}} \qquad ( 2 )$$

$${z}_{g} = round ( {q}_{min} - min ( {W}_{g} ) / {s}_{g} ) \qquad ( 3 )$$

where qₘₐₓ and qₘᵢₙ are the largest and smallest numbers that can be represented by the integer type (depending on the number of bits).

To dequantize the integer representations, it is possible to subtract the zero point and multiply it by the scale:

$$dequant ( quant ( {W}_{g} ) ) = {s}_{g} \cdot ( quan t ( {W}_{g} ) - {z}_{g} ) \qquad ( 4 )$$

A key challenge for quantization, as can be appreciated by equations (2) and (3), is that the quantization parameters are very sensitive to outliers, because they heavily depend on the maximum and minimum weights of a group. These outlier weights cause the scale parameter s_{g} to be large, which in turn increases the expected quantization error.

One of the significant advantages of the methods and systems disclosed herein is that they can use invariant transformations to alleviate this effect on quantization error and ultimately improve quantization performance.

The methods and systems described herein provide a framework that systematically explores invariant transformations in neural networks to improve quantization performance.

The inventors have appreciated that invariant transformations do not alter the output of a model if that model is not quantized, though such transformations may have different quantization performances because round(•) is not invertible in the quant and dequant functions. Unlike previous work that studies one type of invariance at a time, the methods and systems described herein provide a unified technical solution that encompasses different invariant transformations.

For example, scaling (see [3]) and rotation (see [4]) are explored in previous disclosures and are simply special cases when used in the accordance with the methods and systems described herein. Moreover, the methods and systems described herein allow for the novel exploration of permutation invariance, as described in more detail elsewhere herein.

Specifically, given a model [symbol] and its trained parameters θ₀, the objective of embodiments of the methods and systems described herein may be formulated as the following constrained optimization problem:

$${minimize}_{θ} ℒ ( X , quant ( θ ) ) \qquad ( 5 )$$

$$subject to \text{?} ( x ; θ ) = \text{?} ( x ; {θ}_{0} ) , ∀ x \qquad ( 6 )$$

where [symbol] is a loss function (such as the cross-entropy loss) and X is a small batch of calibration data. Equation (6) is the invariance constraint that holds for every possible input x, which is not necessarily the samples in the batch. This ensures that the search space only contains parameters that yield the same model as the original one.

The inventors have appreciated that equation (6) cannot be easily satisfied, because the equality has to hold for all inputs. The embodiments of the methods and systems described herein therefore restrict the search space to invariant transformations in the linear feed-forward blocks of the Transformer architecture:

$$z = {W}_{d o w n} f ( {W}_{u p} x + {b}_{u p} ) + {b}_{d o w n} \qquad ( 7 )$$

where the Ws and bs are the weights and biases of the up and down projections, and ƒ is the activation function, such as ReLU, as disclosed in [1].

In some embodiments, invariances can be calculated as follows. Permutation invariance is when if the order of the neurons in a layer is changed, the network remains invariant. In some embodiments, for permutation invariance, let P be a permutation matrix, i.e., every element is binary, and every row/column has exactly one element that is 1. The transpose P^{T} cancels out the permutation effect, as P^{T}P=I must hold.

Multiplying P to Wᵤₚ and bᵤₚ, and P^{T} to W_{down} on the appropriate side results in:

$$( {W}_{d o w n} {P}^{T} ) f ( ( P {W}_{u p} ) x + P {b}_{u p} ) + {b}_{d o w n} \qquad ( 8 )$$

$$= {W}_{d o w n} ( {P}^{T} P ) f ( {W}_{u p} x + {b}_{u p} ) + {b}_{d o w n} = z \qquad ( 9 )$$

which is the same as the original model (7). Here, equation (13) follows because permutation can be equivalently applied before or after the activation function, i.e., ƒ(xP)=ƒ(x)P. This results in the permuted parameters:

$${\overline{W}}_{u p} = P {W}_{up} , {\overline{b}}_{u p} = P {b}_{u p} \qquad ( 10 )$$

$${\overline{W}}_{d o w n} = {W}_{d o w n} {P}^{T} \qquad ( 11 )$$

As will be appreciated, the transformed parameters can be efficiently obtained by indexing the original parameters, rather than matrix-matrix multiplications. Permutations per se are non-differentiable, but they are special cases of orthogonal transformations, which are differentiable and have been disclosed in [28]. However, they use gradient-based optimization, and it cannot effectively explore permutations, because local minima are formed in a non-convex fashion due to the permutation symmetry.

In regard to scaling, for a certain activation function (such as ReLU and LeakyReLU), it is possible to obtain an invariant model by scaling features. Let s be a scaling vector, i.e., sᵢ is the scaling factor for the ith dimension. For linear algebra notations, a scaling matrix S=diag(s), may be defined, thus resulting in:

$$( {W}_{d o w n} {S}^{- 1} ) f ( ( S {W}_{u p} ) x + S {b}_{u p} ) + {b}_{d o w n} \qquad ( 12 )$$

$$= {W}_{d o w n} ( {S}^{- 1} S ) f ( {W}_{u p} x + {b}_{u p} ) + {b}_{d o w n} = z \qquad ( 13 )$$

The scaled parameters may be given by:

$${\overline{W}}_{u p} = S {W}_{u p} , {\overline{b}}_{u p} = S {b}_{u p} \qquad ( 14 )$$

$${\overline{W}}_{d o w n} = {W}_{d o w n} {S}^{- 1} \qquad ( 15 )$$

In implementation, it is not necessary to calculate S and S⁻¹, but instead to scale a dimension by sᵢ and scale it back by its reciprocal 1/sᵢ.

The systems and methods described here have been tested using Open Pre-Trained Transformer (OPT) models, as disclosed in [46], with the ReLU function. For other activation functions, scaling Wᵤₚ and W_{down} is not invariant, but can be employed as an approximation. Moreover, scaling invariance can be achieved for W_{down} and its subsequent LayerNorm operation.

A rotation may also be represented by a matrix R, and its inverse is R^{T}. However, rotations are not invariant for non-linear activation functions, meaning that applying rotation in a similar way does not satisfy equation (6):

$$( {W}_{d o w n} {R}^{T} ) f ( ( R {W}_{u p} ) x + R {b}_{u p} ) + {b}_{d o w n} \qquad ( 16 )$$

$$\neq {W}_{d o w n} ( {R}^{T} R ) f ( {W}_{u p} x + {b}_{u p} ) + {b}_{d o w n} = z \qquad ( 17 )$$

Nevertheless, if the rotation degree is small, then the values can be mostly recovered by an inverse rotation. This is verified empirically, as described in more detail elsewhere herein, where an original 13B OPT model achieves a cross-entropy loss of 2.31528 on the WikiText-2 dataset; with rotations in accordance with the present disclosure, the cross-entropy is 2.31525, which demonstrates a difference of only 0.001%. Therefore, equation (16) can be considered as an approximate invariant model, leading to rotated parameters:

$${\overline{W}}_{u p} = R {W}_{u p} , {\overline{b}}_{u p} = R {b}_{u p} \qquad ( 18 )$$

$${\overline{W}}_{d o w n} = {W}_{d o w n} {R}^{T} \qquad ( 19 )$$

To construct the rotation, a d-dimensional space (assuming d is even) is partitioned into pairs of two dimensions. This simplified treatment is similar to that for rotary embeddings, as disclosed in [38]. Formally, R can be represented by a block diagonal matrix given rotation angles φ₁, . . . , φ_{d/2}

$$R = 0.8 [ \begin{matrix}cos {ϕ}_{1} & - sin {ϕ}_{1} & … & 0 & 0 \\ sin {ϕ}_{1} & cos {ϕ}_{1} & … & 0 & 0 \\ ⋮ & ⋮ & ⋱ & ⋮ & ⋮ \\ 0 & 0 & … & cos {ϕ}_{d / 2} & - sin {ϕ}_{d / 2} \\ 0 & 0 & … & sin {ϕ}_{d / 2} & cos {ϕ}_{d / 2}\end{matrix} ] \qquad ( 20 )$$

The rotation transformation described herein is different from that disclosed in [28], in which orthogonal transformation are referred to as “rotations”. As will be appreciated by the skilled reader, orthogonal transformations need not be rotations.

The methods and systems disclosed herein permit the exploration of permutation, scaling, and rotation, which can be further combined as:

$${\overline{W}}_{u p} = P S R {W}_{up} , {\overline{b}}_{u p} = P S R {b}_{u p} \qquad ( 21 )$$

$${\overline{W}}_{d o w n} = {W}_{d o w n} {R}^{T} {S}^{- 1} {P}^{T} \qquad ( 22 )$$

As will be appreciated by the skilled reader, the order of the transformations can be interchanged, as long as they are properly inverted in the down projection. In some embodiments, P, S, and R are not stored as matrices but they are rather stored as a permutation vector π, a scale coefficient vector s, and a rotation degree vector φ.

With the proposed transformation, the optimization problem (5) is reduced to the search of permutation, scaling, and rotation matrices. Despite this, it still cannot be optimized by gradient-based methods because the transformation (such as permutation) may impose binary constraints. Moreover, the quant function produces zero gradient almost everywhere, making the optimization difficult in general.

Accordingly, the methods and systems disclosed herein optimize the above-mentioned transformations through discrete search, using cross-entropy loss and an activation-matching loss as the objective. Let H and H₀ be the activations of the quantized model and the original model, respectively. Loss can be expressed as:

$$ℒ ( X , quant ( θ ) ) = CE ( X , quant ( θ ) ) + α MSE ( H , {H}_{0} ) \qquad ( 23 )$$

where CE refers to the standard cross-entropy loss; MSE computes the mean squared error, guiding the search process based on the activation values of hidden layers; and α is a hyperparameter balancing the two terms.

Once the loss is calculated, the methods and systems of the present disclosure perform a discrete search algorithm 306 in order to determine whether to keep or reject the transformation. Discrete search algorithms that may be used include, but are not limited to, simulated annealing, genetic algorithms, and hill climbing algorithms. Other suitable discrete search algorithms will be known to persons of ordinary skill in the art of machine learning.

With reference FIG. 3, in some embodiments of the present disclosure, the methods and systems disclosed implement a discrete search algorithm 306 known as a hill climbing algorithm.

First, in some embodiments, initialization of all layers is performed at step 301. In some embodiments, this can be performed as shown in the “initialization for each layer” section in Algorithm 1, as set out in more detail elsewhere herein.

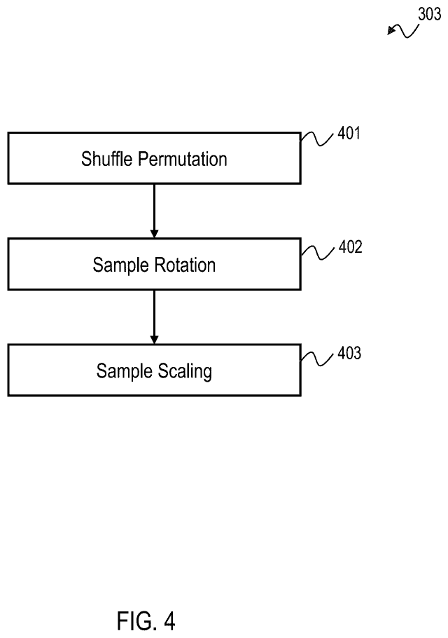

Then, at step 302, a layer of the neural network is selected (e.g., for t=1, 2, . . . do in Algorithm 1). Then, at step 303, a transformation is sampled. In some embodiments, such as the method shown in FIG. 4 and in Algorithm 1, the transformation may combine permutation, rotation, and scaling. As will be appreciated by the skilled reader, however, a transformation in accordance with the present disclosure may comprise one or more of permutation, rotation, and scaling.

For permutation, the neurons in the layer may be reshuffled (e.g., π′←shuffle(πᵢ)) for scaling and rotation, random walk may be adopted and the scale and rotation degree may be sampled based on a Gaussian centered at the current values

$$( e . g . , {s}^{′} ∼ \text{?} ( {s}_{l} , {σ}_{s}^{2} ) and {ϕ}^{′} ∼ \text{?} ( {ϕ}_{l} , {σ}_{r}^{2} ) ) .$$

Then, at step 304, the model may be quantized after applying the transformation. At step 305, the overall loss is calculated (e.g., [symbol] ′← [symbol] _{KL} (X, quant(θ′)+αMSE (H, H₀).

If the overall loss is lower than the best previous best loss ( [symbol] _{best}), the overall loss becomes the best loss at step 308 and the sampled transformation is accepted at step 307. Then, the method returns to selection of the next layer at step 302. If, however, the overall loss is not lower than the best previous loss, then the overall loss is rejected, and the method simply returns to selection of the next layer at step 302.

In some embodiments, the method shown in FIGS. 3 and 4 can be implemented in accordance with Algorithm 1, as set out in more detail elsewhere herein.

In practice, only a subset of the weights in a layer are permuted, scaled, and rotated for each proposed update, and the size of the subset acts as a step size that controls how much to move in the parameter space. A larger step size will result in a lower acceptance rate, while a smaller one will lead to less change in the parameters. In some embodiments, 10% of the neurons within a layer are changed at a time.

Algorithm 1: Activation-Guided Discrete Search

| Input: X: calibration data; | |
|---|---|
| θ₀: initial model parameters | |
| σᵣ, σₛ: standard deviation for scaling and rotation | |
| α: a balancing hyperparameter | |
| H ← [symbol] (X, θ₀) | |
| H₀ ← [symbol] (X, quant(θ₀)) | |
| [symbol] _{best} ← [symbol] _{KL}(X, quant(θ₀)) + αMSE(H, H₀) | |
| θ ← θ₀ | |
| [symbol] Initialization for each layer l | |
| for l = 1, ... , L do | |
| πₗ ← [0,1,2, ... ] ∈ [symbol] ^{d} | No permutation |
| sₗ ← [1,1, ... ] ∈ [symbol] ^{d} | No scaling |
| Φₗ ← [0,0, ... ] ∈ [symbol] ^{d/2} | No rotation |

```
for t = 1,2, ... do
  Sample a layer l
  π′ ← shuffle(πₗ)
  s′ ~ [symbol]   (sₗ, σₛ²)
  Φ′ ~ [symbol]   (Φₗ, σᵣ²)
  θ′ ← apply_transformation(θ, π′, s′, Φ′, l) [symbol]
  ′ ← [symbol]   _{KL}(X, quant(θ′)) + αMSE(H, H₀)
  if [symbol]   ′ < [symbol]   _{best} then
    θ ← θ′, [symbol]   _{best} ← [symbol]   ′
    πₗ ← π′, sₗ ← s′, Φₗ ← Φ′
```

The methods and systems described herein have been evaluated on both language modeling and a selection of popular reasoning tasks. For language modeling, the perplexity scores on the widely used WikiText-2 dataset [30] and the Colossal Clean Crawled Corpus [9] were compared. For reasoning, few-shot evaluation harness was adopted. Specifically, [34] was followed and testing on the following tasks was effectuated:

ARC [6]: a benchmark consisted of multiple choice questions on grade school science. The authors partition their data into an easy subset and a challenging subset, denoted by ARC-E and ARC-C, respectively.

BoolQ [5]: a reading comprehension dataset focusing on yes/no questions.

HellaSwag [45]: a natural language inference benchmark for common sense reasoning.

PIQA [4]: a common sense reasoning benchmark focusing on interactions with the physical world.

WinoGrande [33]: a pronoun resolution dataset, where the task is to choose the correct entity that a pronoun refers to given two options.

The Open Pretrained Transformer (OPT) family of LLMs, ranging from 1.3B to 13B parameters [46] which have been used with many previous methods for quantization, as disclosed in [13], [24] and [34]. The LLM is prompted by five-shot in-context learning samples, similar to that described in [29]. In-context samples may be required.

The 2-bit setting is adopted with a group size of 128 for the main experiment, which is typically included in previous studies but not as their main focus, as disclosed in [25] and [34]. The analysis carried out also experimented with the 3-bit setting.

A small calibration dataset was required to optimize the objective in equation (5). In particular, 32 sequences were used from the Pile corpus [14] in the main experiments, each sequence containing 512 tokens. The calibration set is similar to [25] but smaller than [13] and [34]. Notably, a sequence with 512 tokens is much shorter than the context window of modern LLMs (e.g., OPT has a context of 2048 tokens), which suggests that the calibration with the short sequences is memory-and-computation-efficient due to the quadratic scaling of attention in Transformers.

The balancing hyperparameter a in equation (23) is chosen such that the cross-entropy loss is ten times more important than the activation mean squared error at the beginning of training. For scaling and rotation, the random-walk standard deviations σₛ and σᵣ are needed to sample new candidate values (Algorithm 1); they are set to 1e-2 and 1e-5, respectively. The rotation standard deviation or is much smaller because of high variance if the rotation degrees are large. The above hyperparameters are obtained via a grid search during the pilot study based on the loss on the calibration set. The same hyperparameters may be used across all settings and datasets.

The results and analysis of the above-described experiments will now be set out. The methods and systems disclosed herein represent a general approach that can be applied to existing quantization methods. Popular and state-of-the-art methods were considered: GPTQ quantizes weights sequentially and adjust the remaining weights to compensate for the quantization error [13], AWQ explores the scaling invariance by heuristics [25], and OmniQuant learns the scaling coefficients by gradient updates. In addition, both AWQ and OmniQuant use weight clipping to alleviate outlier weights.

In the experiments, GPTQ and AWQ are replicated by running their provided codebases, as they do not release checkpoints for the 2-bit setting that are focused on; for OmniQuant, the publicly available checkpoint are directly used. In general, similar trends as previous work are achieved. For example, the replication of OmniQuant matches closely with [34].

The main results are presented in Table 1, where performance is shown on both language modeling and downstream reasoning tasks. For reasoning, the average accuracy across six reasoning tasks are reported.

The standard, un-quantized OPT model with the FP16 representation is first examined. As seen in Table 1, larger models consistently achieve lower perplexity scores and higher accuracies, which is expected.

TABLE 1

| | | | | | Colossal Clean | | | | | | | |
|---|---|---|---|---|---|---|---|---|---|---|---|---|
| Dataset | WikiText-2 | | | | Crawled Corpus (C4) | | | | Reasoning Tasks | | | |
| Model size | 1.3B | 2.7B | 6.7B | 13B | 1.3B | 2.7B | 6.7B | 13B | 1.3B | 2.7B | 6.7B | 13B |
| FP16 | 14.62 | 12.47 | 10.86 | 10.13 | 15.73 | 14.10 | 12.54 | 11.93 | 55.50 | 59.71 | 64.62 | 66.11 |
| RTN | 1.30e4 | 5.68e4 | 7.82e3 | 7.65e4 | 7.87e3 | 3.91e4 | 5.50e3 | 3.01e4 | 36.22 | 39.86 | 35.51 | 36.41 |
| GPTQ [13] | 396.28 | 206.06 | 30.31 | 40.20 | 186.67 | 111.27 | 27.80 | 51.85 | 40.93 | 44.39 | 50.18 | 48.57 |
| +method | 213.33 | 103.09 | 27.83 | 29.49 | 117.66 | 67.04 | 26.05 | 26.66 | 42.94 | 45.90 | 50.96 | 51.95 |
| AWQ [25] | 53.57 | 80.24 | 26.11 | 35.89 | 46.82 | 87.14 | 26.33 | 37.36 | 41.69 | 46.45 | 52.91 | 51.85 |
| +method | 41.89 | 50.07 | 22.65 | 26.26 | 38.04 | 40.05 | 23.62 | 27.00 | 44.33 | 49.56 | 53.95 | 55.13 |
| OmniQuant [34] | 23.96 | 18.15 | 14.43 | 12.94 | 29.24 | 22.55 | 17.86 | 16.06 | 47.12 | 50.62 | 56.74 | 59.55 |
| +method | 23.33 | 17.94 | 14.20 | 12.73 | 28.54 | 22.36 | 17.39 | 15.78 | 47.58 | 50.62 | 56.87 | 59.67 |

Table 1 contain the main results. For language modeling on WikiText-2 and C4 corpora, perplexity score (the lower the better) is reported. For reasoning, accuracy averaged across six tasks (the higher the better) is reported.

Next, experiments were conducted with the round-to-nearest (RTN) baseline that applies the standard integer quantization and rounds the model weights with the nearest integer representation. The replication results match exactly with those in [34]. As can be seen, the simple RTN approach performs poorly for low-bit quantization, as it increases the perplexity by orders of magnitude.

For modern quantization methods GPTQ, AWQ, and OmniQuant, they significantly outperform the RTN baseline, with OmniQuant achieving the highest performance, followed by the popular AWQ approach, which is in turn followed by the earlier GTPQ approach.

The methods and systems described herein are then applied and it can be seen that they achieve consistent improvement over the state-of-the-art quantization methods. In particular, substantial improvement over GPTQ and AWQ are achieved, for instance, reducing the language modeling perplexity of GPTQ by 30% to 50% and increasing the reasoning accuracy by 3 points in the 13B setting. Improvement over OmniQuant are more modest, as OmniQuant has already achieved high performance. Nevertheless, the improvement is generally consistent in language modeling and downstream reasoning tasks across model sizes (ranging from 1.3B to 13B). This shows the effectiveness of the methods and systems disclosed herein in both language modeling and downstream tasks, highlighting its generality and practical values.

For ablation, the effectiveness of different transformation types, namely, permutation, scaling, and rotation across language modeling and reasoning tasks were analyzed. Due to the limit of space and computing resources, the AWQ (which the implementation is based on) and the 13B OPT model were considered for the analyses.

As shown in Table 2, every type of transformation alone outperforms AWQ across all tasks except that the permutation-only variant is 0.03 points lower on the BoolQ dataset (which is understandable due to the large number of tasks and settings). It can be observed that permutation and rotation yield more improvement than scaling, as AWQ has already applied scaling based on activation values, making further exploration less effective.

TABLE 2

| Metric | Perplexity ^{↓} | Accuracy ^{↑} | | | | | | | |
|---|---|---|---|---|---|---|---|---|---|
| Dataset | WikiText-2 | C4 | ARC-C | ARC-E | BoolQ | HellaS | PIQA | WinoG | Avg |
| FP16 | 10.13 | 11.93 | 40.10 | 71.51 | 68.47 | 70.59 | 77.26 | 68.75 | 66.11 |
| RTN | 76479.03 | 30125.99 | 25.60 | 26.47 | 38.23 | 25.59 | 50.33 | 52.25 | 36.41 |
| AWQ | 35.89 | 37.36 | 26.37 | 49.75 | 62.81 | 48.65 | 68.44 | 55.09 | 51.85 |
| +method-Permutation | 29.95 | 31.34 | 28.50 | 53.49 | 62.78 | 52.12 | 69.15 | 56.59 | 53.77 |
| +method-Scaling | 33.19 | 36.05 | 28.07 | 51.18 | 62.87 | 50.75 | 68.61 | 56.04 | 52.92 |
| +method-Rotation | 30.21 | 30.94 | 27.90 | 53.11 | 63.24 | 52.84 | 70.40 | 58.17 | 54.28 |
| +method (All) | 26.26 | 27.00 | 28.16 | 54.63 | 63.94 | 54.51 | 70.95 | 58.56 | 55.13 |

Table 2 contains the results of an ablation study for permutation, scaling, and rotation with the 13B OPT model.

Moreover, combining all three transformations improves performance by 3 to 9 points in language modeling and 1 to 2 average points on reasoning tasks, compared with individual transformations. This suggests that methods and system disclosed herein (i.e., “+method”) represents a technical solution that facilitates synergistic exploration of different types of invariance for neural network quantization.

In terms of the analysis of the number of bits and group size, the methods and systems described herein were evaluated under different quantization settings, including 1-, 2-, and 3-bit quantization using 64 and 128 as the group size. Results are presented in Table 3. Higher-bit quantization settings are omitted, as the performance of existing methods is nearly saturated with the 3-bit setting (only 1 point lower in reasoning than FP16), but the performance of 1-bit and 2-bit settings remains low. This highlights the challenge of the ultra-low-bit setup.

TABLE 3

| Bit | Group | Bits/Param | Method | WikiText-2 | C4 | ARC-C | ARC-E | BoolQ | HellaS | PIQA | WinoG | Avg |
|---|---|---|---|---|---|---|---|---|---|---|---|---|
| — | — | 16 | FP16 | 10.13 | 11.93 | 40.10 | 71.51 | 68.47 | 70.59 | 77.26 | 68.75 | 66.11 |
| 1 | 64 | 1.25 | AWQ | 93672.90 | 43563.64 | 25.94 | 26.14 | 37.83 | 26.02 | 49.89 | 49.72 | 35.92 |
| | | | +method | 6823.46 | 4561.87 | 26.28 | 26.64 | 37.83 | 26.27 | 50.05 | 51.22 | 36.38 |
| 2 | 64 | 2.25 | AWQ | 20.26 | 23.54 | 29.44 | 54.59 | 64.43 | 52.72 | 69.42 | 55.64 | 54.37 |
| | | | +method | 19.02 | 20.96 | 32.00 | 59.22 | 64.31 | 56.40 | 71.27 | 59.04 | 57.04 |
| 2 | 128 | 2.125 | AWQ | 35.89 | 37.36 | 26.37 | 49.75 | 62.81 | 48.65 | 68.44 | 55.09 | 51.85 |
| | | | +method | 26.26 | 27.00 | 28.16 | 54.63 | 63.94 | 54.51 | 70.95 | 58.56 | 55.13 |
| 3 | 128 | 3.125 | AWQ | 10.81 | 12.76 | 38.99 | 69.53 | 69.42 | 68.43 | 76.44 | 67.25 | 65.01 |
| | | | +method | 10.77 | 12.77 | 38.74 | 69.49 | 69.63 | 68.73 | 76.44 | 66.22 | 64.88 |

Table 3 contains results of performance of the 13B OPT model with different number of bits and group sizes. First, the effect of the number of bits is compared. Since the 1-bit setting essentially means each weight can only take two values, it becomes challenging and thus a smaller group size of 64 (implying a more fine-grained quantization) is used during the comparison. Still, the 1-bit setting yields very high perplexity and low accuracy for AWQ. The methods and systems disclosed herein significantly reduces the perplexity by an order of magnitude, but it is not enough to recover the reasoning capability. For the 2-bit setting, a seemingly small improvement of 1 point on WikiText-2 is seen, but a 3-point improvement in reasoning is achieved. For the 3-bit setting, the methods and systems described herein perform similarly to AWQ, whose performance is already close to FP16, leaving little room for further improvement.

2-bit quantization with different group sizes was also compared. As can be seen, a smaller group size enables a more fine-grained quantization, yielding a higher performance with a slightly larger memory cost.

Overall, the methods and systems disclosed herein work generally well in different quantization settings, achieving higher or similar performance compared with the AWQ approach. In particular, the ultra-low 2-bit setup allows for a memory saving of 85%, while the approach yields multi-point improvement compared with the baseline, achieving a balance between performance and model size.

In terms of the effect of activation matching, the search objective is shown in equation (23), which combines the task-oriented cross-entropy loss and an activation-matching loss. Although the activation matching can be applied to all layers, it was found that doing so for the 40-layer 13B OPT model requires a large memory. Therefore, the matching for 10 layers in the main experiment was restricted and the effect of matched layers are analyzed in Table 4.

TABLE 4

| | Extra | | | | | | | | | |
|---|---|---|---|---|---|---|---|---|---|---|
| Method | memory | WikiText-2 | C4 | ARC-C | ARC-E | BoolQ | HellaSwag | PIQA | WinoGrande | Avg |
| AWQ | — | 35.89 | 37.36 | 26.37 | 49.75 | 62.81 | 48.65 | 68.44 | 55.09 | 51.85 |
| +method | 0.00 GiB | 29.26 | 30.36 | 27.47 | 53.28 | 63.64 | 53.10 | 70.13 | 59.43 | 54.51 |
| w/0 | | | | | | | | | | |
| layers | | | | | | | | | | |
| +method | 0.31 GiB | 27.87 | 29.27 | 29.01 | 54.21 | 64.19 | 54.00 | 70.24 | 56.91 | 54.76 |
| w/1 | | | | | | | | | | |
| layers | | | | | | | | | | |
| +method | 1.56 GiB | 27.09 | 27.92 | 27.73 | 54.67 | 62.78 | 54.47 | 69.91 | 58.96 | 54.75 |
| w/5 | | | | | | | | | | |
| layers | | | | | | | | | | |
| +method | 3.13 GiB | 26.26 | 27.00 | 28.16 | 54.63 | 63.94 | 54.51 | 70.95 | 58.56 | 55.13 |
| w/10 | | | | | | | | | | |
| layers | | | | | | | | | | |

Table 4 contains an analysis on the number of layers used for activation matching for the 13B OPT model. The extra memory needed is based on 32 sequences of 512-token calibration samples.

It can be seen that matching more layers generally leads to higher performance, as the activation-matching loss provides guidance throughout the deep neural network. The effect is analogous to intermediate-layer matching in knowledge distillation, as disclosed in [35] and [21].

Notice that activation matching comes with an overhead of memory during the search process because of the need to store the activation values for the calibration samples. When activation matching is disabled (w/0 layers), the methods and systems disclosed herein still consistently outperforms AWQ across all tasks without any memory overhead. This suggests that an end user who has enough GPU memory to perform inference with a quantized model would also have enough memory to apply the methods disclosed herein to improve quantization performance.

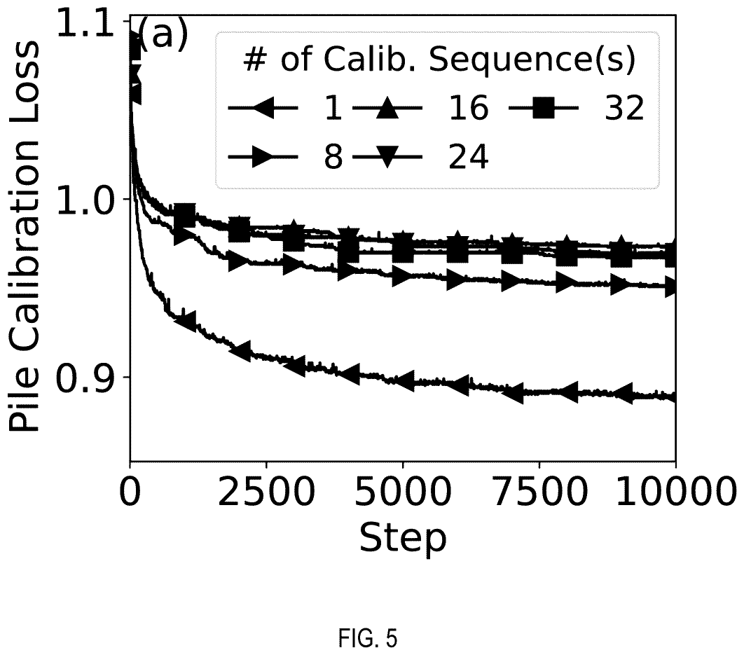

In terms of the number of calibration sequences, how the size of the calibration dataset affects the methods and systems described herein was also studied. Specifically, the methods and systems described herein were evaluated using 1, 8, 16, 24, and 32 sequences for calibration, with each sequence containing 512 tokens. FIGS. 5, 6 and 7 show optimization curves for the first 10K steps, which is generally sufficient for the methods and systems described herein to make significant progress.

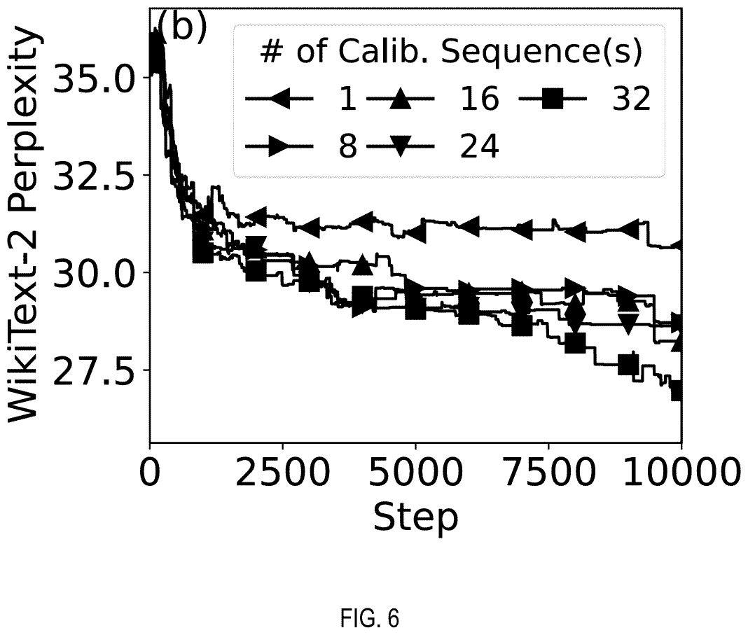

As shown in FIG. 5 and FIG. 6, both the calibration loss and the test perplexity consistently decrease as the search step is increased. As expected, using fewer calibration sequences generally makes the calibration loss decrease faster, but that also leads to slower improvement on the test set.

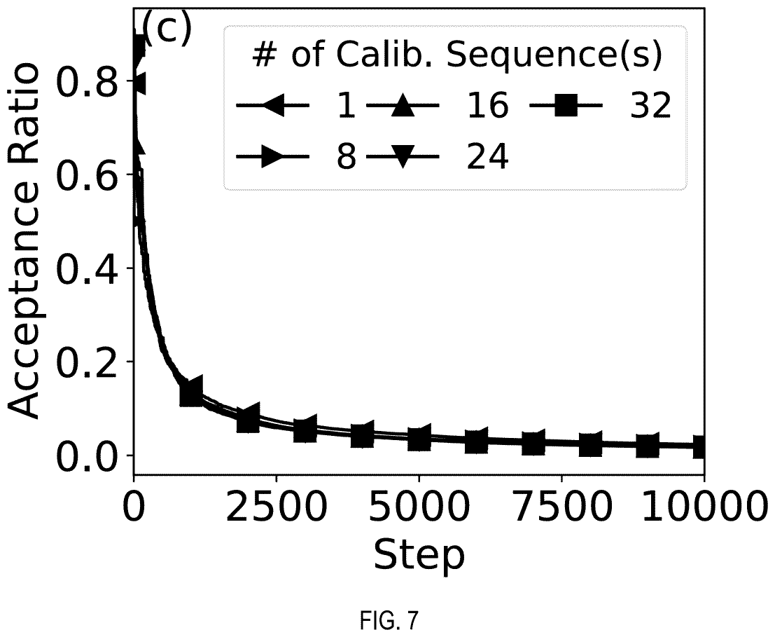

The acceptance rate of the methods and systems disclosed herein are shown in FIG. 7. The optimization described with respect to Algorithm 1 performs a random walk-style hill-climbing search, where a new transformation is accepted if it leads to a lower loss. It can be seen that the acceptance rate is around 80% at the beginning, showing that the search is highly efficient despite using random walk. With more steps, the acceptance rate steadily decreases and eventually flattens out, as the search algorithm empirically converges.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures.

For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

### REFERENCES

[1] Agarap, A. Deep learning using rectified linear units (ReLU). arXiv preprint arXiv:1803.08375, 2018.
[2] Ashkboos, S., Mohtashami, A., Croci, M. L., Li, B., Jaggi, M., Alistarh, D., Hoefler, T., and Hensman, J. QuaRot: Outlier-free 4-bit inference in rotated LLMs. In Advances in Neural Information Processing Systems, 2024.
[3] Bengio, Y., Leonard, N., and Courville, A. Estimating or propagating gradients through stochastic neurons for conditional computation. arXiv preprint arXiv:1308.3432, 2013.
[4] Bisk, Y., Zellers, R., Gao, J., Choi, Y., et al. PIQA: Reasoning about physical commonsense in natural language. In Proceedings of the AAAI Conference on Artificial Intelligence, pp. 7432-7439, 2020.
[5] Clark, C., Lee, K., Chang, M.-W., Kwiatkowski, T., Collins, M., and Toutanova, K. BoolQ: Exploring the surprising difficulty of natural yes/no questions. In Proceedings of the Conference of the North American Chapter of the Association for Computational Linguistics: Human Language Technologies, pp. 2924-2936, 2019.
[6] Clark, P., Cowhey, I., Etzioni, O., Khot, T., Sabharwal, A., Schoenick, C., and Tafjord, O. Think you have solved question answering? Try ARC, the AI2 reasoning challenge. arXiv preprint arXiv:1803.05457, 2018.
[7] Courbariaux, M., Bengio, Y., and David, J.-P. BinaryConnect: Training deep neural networks with binary weights during propagations. In Advances in Neural Information Processing Systems, 2015.
[8] Dettmers, T., Lewis, M., Belkada, Y., and Zettlemoyer, L. GPT3.int8( ) 8-bit matrix multiplication for transformers at scale. In Advances in Neural Information Processing Systems, pp. 30318-30332, 2022.
[9] Dodge, J., Sap, M., Marasović, A., Agnew, W., Ilharco, G., Groeneveld, D., Mitchell, M., and Gardner, M. Documenting large webtext corpora: A case study on the Colossal Clean Crawled Corpus. In Proceedings of the Conference on Empirical Methods in Natural Language Processing, pp. 1286-1305, 2021.
[10] Dubey, A., Jauhri, A., Pandey, A., Kadian, A., Al-Dahle, A., Letman, A., Mathur, A., Schelten, A., Yang, A., Fan, A., et al. The Llama 3 herd of models. arXiv preprint arXiv:2407.21783, 2024.
[11] Egiazarian, V., Panferov, A., Kuznedelev, D., Frantar, E., Babenko, A., and Alistarh, D. Extreme compression of large language models via additive quantization. In Proceedings of the International Conference on Machine Learning, 2024.
[12] Frantar, E. and Alistarh, D. Optimal brain compression: A framework for accurate post-training quantization and pruning. In Advances in Neural Information Processing Systems, pp. 4475-4488, 2022.
[13] Frantar, E., Ashkboos, S., Hoefler, T., and Alistarh, D. GPTQ: Accurate post-training quantization for generative pre-trained transformers. In International Conference on Learning Representations, 2023.
[14] Gao, L., Biderman, S., Black, S., Golding, L., Hoppe, T., Foster, C., Phang, J., He, H., Thite, A., Nabeshima, N., et al. The Pile: An 800 GB dataset of diverse text for language modeling. arXiv preprint arXiv:2101.00027, 2020.
[15] Goldberg, D. What every computer scientist should know about floating-point arithmetic. ACM Computing Surveys, 23 (1): 5-48, 1991.
[16] Gong, Y., Liu, L., Yang, M., and Bourdev, L. Compressing deep convolutional networks using vector quantization. In International Conference on Learning Representations, 2015.
[17] Gray, R. Vector quantization. IEEE ASSP Magazine, 10 (2):0 4-29, 1984.
[18] Han, S., Mao, H., and Dally, W. J. Deep compression: Compressing deep neural networks with pruning, trained quantization and huffman coding. In International Conference on Learning Representations, 2016.
[19] Hassibi, B., Stork, D., and Wolff, G. Optimal brain surgeon: Extensions and performance comparisons. In Advances in Neural Information Processing Systems, 1993.
[20] Jacob, B., Kligys, S., Chen, B., Zhu, M., Tang, M., Howard, A., Adam, H., and Kalenichenko, D. Quantization and training of neural networks for efficient integer-arithmetic-only inference. In Proceedings of the IEEE Conference on Computer Vision and Pattern Recognition, pp. 2704-2713, 2018.
[21] Jiao, X., Yin, Y., Shang, L., Jiang, X., Chen, X., Li, L., Wang, F., and Liu, Q. TinyBERT: Distilling BERT for natural language understanding. In Findings of the Association for Computational Linguistics: EMNLP 2020, pp. 4163-4174, 2020.
[22] Koster, U., Webb, T., Wang, X., Nassar, M., Bansal, A. K., Constable, W., Elibol, O., Gray, S., Hall, S., Hornof, L., Khosrowshahi, A., Kloss, C., Pai, R. J., and Rao, N. Flexpoint: An adaptive numerical format for efficient training of deep neural networks. In Advances in Neural Information Processing Systems, 2017.
[23] Krishnamoorthi, R. Quantizing deep convolutional networks for efficient inference: A whitepaper. arXiv preprint arXiv:1806.08342, 2018.
[24] Lin, H., Xu, H., Wu, Y., Cui, J., Zhang, Y., Mou, L., Song, L., Sun, Z., and Wei, Y. DuQuant: Distributing outliers via dual transformation makes stronger quantized LLMs. In Advances in Neural Information Processing Systems, 2024.
[25] Lin, J., Tang, J., Tang, H., Yang, S., Chen, W.-M., Wang, W.-C., Xiao, G., Dang, X., Gan, C., and Han, S. AWQ: Activation-aware weight quantization for on-device LLM compression and acceleration. In Proceedings of Machine Learning and Systems, pp. 87-100, 2024.
[26] Lin, Z., Courbariaux, M., Memisevic, R., and Bengio, Y. Neural networks with few multiplications. In International Conference on Learning Representations, 2016.
[27] Liu, F., Zhao, W., He, Z., Wang, Y., Wang, Z., Dai, C., Liang, X., and Jiang, L. Improving neural network efficiency via post-training quantization with adaptive floating-point. In Proceedings of the IEEE/CVF International Conference on Computer Vision, pp. 5281-5290, 2021.
[28] Liu, Z., Zhao, C., Fedorov, I., Soran, B., Choudhary, D., Krishnamoorthi, R., Chandra, V., Tian, Y., and Blankevoort, T. SpinQuant: LLM quantization with learned rotations. arXiv preprint arXiv:2405.16406, 2024.
[30] Li, S., Ning, X., Wang, L., Liu, T., Shi, X., Yan, S., Dai, G., Yang, H., and Wang, Y. Evaluating quantized large language models. In Proceedings of the International Conference on Machine Learning, pp. 28480-28524, 2024.
[39] Merity, S., Xiong, C., Bradbury, J., and Socher, R. Pointer sentinel mixture models. In International Conference on Learning Representations, 2022.
[31] Micikevicius, P., Narang, S., Alben, J., Diamos, G., Elsen, E., Garcia, D., Ginsburg, B., Houston, M., Kuchaiev, O., Venkatesh, G., et al. Mixed precision training. In International Conference on Learning Representations, 2018.
[32] OpenAI. Introducing ChatGPT, 2022.
[33] Sakaguchi, K., Le Bras, R., Bhagavatula, C., and Choi, Y. WinoGrande: An adversarial Winograd Schema Challenge at scale. In Proceedings of the AAAI Conference on Artificial Intelligence, pp. 8732-8740, 2020.
[34] Shao, W., Chen, M., Zhang, Z., Xu, P., Zhao, L., Li, Z., Zhang, K., Gao, P., Qiao, Y., and Luo, P. OmniQuant: Omnidirectionally calibrated quantization for large language models. In International Conference on Learning Representations, 2024.
[35] Sun, S., Cheng, Y., Gan, Z., and Liu, J. Patient knowledge distillation for BERT model compression. In Proceedings of the Conference on Empirical Methods in Natural Language Processing and the International Joint Conference on Natural Language Processing, pp. 4323-4332, 2019.
[36] Sun, X., Choi, J., Chen, C.-Y., Wang, N., Venkataramani, S., Srinivasan, V. V., Cui, X., Zhang, W., and Gopalakrishnan, K. Hybrid 8-bit floating point (HFP8) training and inference for deep neural networks. In Advances in Neural Information Processing Systems, 2019.
[37] Sun, X., Wang, N., Chen, C.-Y., Ni, J., Agrawal, A., Cui, X., Venkataramani, S., El Maghraoui, K., Srinivasan, V. V., and Gopalakrishnan, K. Ultra-low precision 4-bit training of deep neural networks. In Advances in Neural Information Processing Systems, pp. 1796-1807, 2020.
[38] Su, J., Ahmed, M., Lu, Y., Pan, S., Bo, W., and Liu, Y. RoFormer: Enhanced transformer with rotary position embedding. Neurocomputing, 568:0 127063, 2024.
[39] Tseng, A., Chee, J., Sun, Q., Kuleshov, V., and De Sa, C. QuIP #: Even better LLM quantization with Hadamard incoherence and lattice codebooks. In Proceedings of the International Conference on Machine Learning, 2024.
[40] Wang, N., Choi, J., Brand, D., Chen, C.-Y., and Gopalakrishnan, K. Training deep neural networks with 8-bit floating point numbers. In Advances in Neural Information Processing Systems, 2018.
[41] Wei, X., Zhang, Y., Li, Y., Zhang, X., Gong, R., Guo, J., and Liu, X. Outlier Suppression+: Accurate quantization of large language models by equivalent and effective shifting and scaling. In Proceedings of the Conference on Empirical Methods in Natural Language Processing, pp. 1648-1665, 2023.
[42] Wu, H., Judd, P., Zhang, X., Isaev, M., and Micikevicius, P. Integer quantization for deep learning inference: Principles and empirical evaluation. arXiv preprint arXiv:2004.09602, 2020.
[43] Xiao, G., Lin, J., Seznec, M., Wu, H., Demouth, J., and Han, S. SmoothQuant: Accurate and efficient post-training quantization for large language models. In Proceedings of the International Conference on Machine Learning, pp. 38087-38099, 2023.
[44] Yuan, Z., Niu, L., Liu, J., Liu, W., Wang, X., Shang, Y., Sun, G., Wu, Q., Wu, J., and Wu, B. RPTQ: Reorder-based post-training quantization for large language models. arXiv preprint arXiv:2304.01089, 2023.
[45] Zellers, R., Holtzman, A., Bisk, Y., Farhadi, A., and Choi, Y. HellaSwag: Can a machine really finish your sentence? In Proceedings of the Annual Meeting of the Association for Computational Linguistics, pp. 4791-4800, 2019.
[46] Zhang, S., Roller, S., Goyal, N., Artetxe, M., Chen, M., Chen, S., Dewan, C., Diab, M., Li, X., Lin, X. V., et al. OPT: Open pre-trained transformer language models. arXiv preprint arXiv:2205.01068, 2022.
[47] Zhou, S., Wu, Y., Ni, Z., Zhou, X., Wen, H., and Zou, Y. DoReFa-Net: Training low bitwidth convolutional neural networks with low bitwidth gradients. arXiv preprint arXiv:1606.06160, 2016.

1. A method of post-training quantization of a neural network, the method comprising:
sequentially selecting one of a plurality of layers in the neural network; and
for each selected layer:
sampling a transformation associated with the selected layer;
quantizing the neural network using the sampled transformation;
calculating a loss associated with the quantization;
determining the acceptability of the calculated loss using a discrete search algorithm; and
accepting the sampled transformation if the loss is determined to be acceptable.

2. The method of claim 1, wherein the discrete search algorithm is one of a simulated annealing algorithm, a genetic algorithm or a hill climbing algorithm.

3. The method of claim 2, wherein the discrete search algorithm is a hill climbing algorithm and determining the acceptability of the calculated loss further comprises:
accepting the sampled transformation only if the calculated loss is smaller than a smallest previous loss associated with the same layer.

4. The method of claim 1, wherein the transformation comprises two or more of:
a permutation of a plurality of weights in the selected layer;
a scaling of a plurality of weights in the selected layer; and
a rotation of a plurality of weights in the selected layer.

5. The method of claim 4, wherein quantizing further comprising using standard asymmetric integer group quantization in which weight matrices are divided into groups of contiguous memory space.

6. The method of claim 5, wherein the permutation comprises reshuffling the weights of neurons in the selected layer and the scaling and the rotation each comprise using a random walk technique and sampling the scale and rotation degrees based on a Gaussian distribution centered at current values.

7. The method of claim 1, wherein the step of sequentially selecting one of a plurality of layers in the neural network comprises selecting one or more layers multiple times.

8. The method of claim 1, wherein the calculated loss is based in part on the cross-entropy loss and an activation matching loss associated with the transformation.

9. The method of claim 8, wherein the calculated loss is determined using the equation:
$${ℒ}^{′} ← CE ( X , quant ( {θ}^{′} ) ) + α M S E ( H , {H}_{0} ) ) .$$
where X is a batch of calibration data, H and H₀ are the activations of the quantized model and the original model, respectively, θ′ are model parameters, CE is the standard cross-entry loss, MSE is a calculation of the mean squared error, and α is a hyperparameter.

10. A system for post-training quantization of a neural network, the system comprising:
at least one database having stored thereon a neural network;
at least one processor communicatively coupled with the at least one database; and
at least one memory communicatively coupled to the at least one processor, the at least one memory having stored thereon computer program code that is executable by the at least one processor and that, when executed by the at least one processor, causes the at least one processor to perform a method comprising:
sequentially selecting one of a plurality of layers in the neural network; and
for each selected layer:
sampling a transformation associated with the selected layer;
quantizing the neural network using the sampled transformation;
calculating a loss associated with the quantization;
determining the acceptability of the calculated loss using a discrete search algorithm; and
accepting the sampled transformation if the loss is determined to be acceptable.

11. The system of claim 10, wherein the discrete search algorithm is one of a simulated annealing algorithm, a genetic algorithm or a hill climbing algorithm.

12. The system of claim 11, wherein the discrete search algorithm is a hill climbing algorithm and determining the acceptability of the calculated loss further comprises:
accepting the sampled transformation only if the calculated loss is smaller than a smallest previous loss associated with the same layer.

13. The system of claim 10, wherein the transformation comprises two or more of:
a permutation of a plurality of weights in the selected layer;
a scaling of a plurality of weights in the selected layer; and
a rotation of a plurality of weights in the selected layer.

14. The system of claim 13, wherein quantizing further comprising using standard asymmetric integer group quantization in which weight matrices are divided into groups of contiguous memory space.

15. The system of claim 14, wherein the permutation comprises reshuffling the weights of neurons in the selected layer and the scaling and the rotation each comprise using a random walk technique and sampling the scale and rotation degrees based on a Gaussian distribution centered as current values.

16. The system of claim 10, wherein the step of sequentially selecting one of a plurality of layers in the neural network comprises selecting one or more layer multiple times.

17. The system of claim 10, wherein the calculated loss is based in part on the cross-entropy loss and an activation matching loss associated with the transformation.

18. The system of claim 17, wherein the calculated loss is determined using the equation:
$${ℒ}^{′} ← CE ( X , quant ( {θ}^{′} ) ) + α MSE ( H , {H}_{0} ) ) .$$
where X is a batch of calibration data, H and H₀ are the activations of the quantized model and the original model, respectively, θ′ are model parameters, CE is the standard cross-entry loss, MSE is a calculation of the mean squared error, and α is a hyperparameter.

19. At least one non-transitory computer readable medium having stored thereon computer program code that is executable by at least one processor and that, when executed by the at least one processor, causes the at least one processor to perform a method comprising:
sequentially selecting one of a plurality of layers in the neural network; and
for each selected layer:
sampling a transformation associated with the selected layer;
quantizing the neural network using the sampled transformation;
calculating a loss associated with the quantization;
determining the acceptability of the calculated loss using a discrete search algorithm; and
accepting the sampled transformation if the loss is determined to be acceptable.
